(19) United States
(12) Patent Application Publication
(10) Pub. No.: US 2002/0116219 A1
(43) Pub. Date: Aug. 22, 2002

(54) Method of wireless medical database creation and retrieval

(76) Inventors: Effiong Ibok, Sunnyvale, CA (US); Effiong Utuk, Austin, TX (US)

Correspondence Address: MEDSCAN TECHNOLOGIES INC., 1005 E. HOMESTEAD RD., SUNNYVALE, CA, 94087, US

(21) Appl. No.: 09/789,058

(22) Filed: Feb. 19, 2001

(51) Int. Cl. G06F 17/60

(52) U.S. Cl. 705/2

(57) ABSTRACT

This invention discloses a method of editing, accessing, creating, and retrieving database information in a medical services business wirelessly. The wireless device could be a PDA, laptop, a computer, or any telephony device. The database information extends from pre-admission, to treatment, to post-admission, hospitalization, and post-hospitalization data. It also covers EMS operations and interactions with hospitals. It covers patient and physician history and laboratory diagnosis. It describe method of wirelessly generating healthcare provider notes and the authentication of such notes. The information transmittal is secured by an elaborate authenticating scheme disclosed here. The disclosure covers all fields and activities of current medical care now transformed from wired or paper to wireless by various devices.

### FIELD OF INVENTION

The present invention relates to a database creation and management system comprising wireless interaction and interface with a host server. The present invention has its particular application in healthcare delivery industry and the creation, access and retrieval of information in that field.

### BACKGROUND OF INVENTION

The art of medical care is anchored in paper files. These files document the history of a patient from the time he enters into a practitioner's care until he lives. It constitutes the Medical History of the patient. Supplementing this are the doctor's and other caregiver's notes which are inserted into the files or in a central server but still constitute the “Patient's History’. This compilation of information soon gets to be quite bulky and some hospitals in quite recent times have gone on to computerize their system. This computerization, quite often translates into nothing more than transcribing the paper information into a database and accessing this database via some dummy terminal. The active care of the patient is still underpinned by paper transactions and documentation.

An inevitable outcome of these paper transactions is error in interpretations. The medication prescribed by a physician in long hand, for example, is subject to error because the nurse or the pharmacist dispensing this medication cannot completely identify the medication prescribed. Additionally, even when there is no error in the prescription interpretation, the ever increasing overlap in the sound and spelling of names of medications that can in fact perform very different functions and can indeed lead to grievous reactions were one to be given in place of the other or in a dosage in excess of that for which the statistics of the patient dictates.

This method of medical care is subject to human error which could prove fatal. Aside from the susceptibility to error, there is the need for the physician or delivery practitioner to transcribe his notes from the portable tape recorder to text which are sometimes long hand for entry into the server database. This is very time-consuming and takes the physician away from the work that truly utilizes his skills.

The present invention recognizes that other methods of accessing databases exist such as mobile computers or even mobile computers with wireless modems. This option is bulky and it is inconvenient at the very least to lug a laptop to the observation room or other venue where documentation is required. Additionally, the bulk of the data entry and retrieval is still paper-based.

### BRIEF DESCRIPTION OF INVENTION

The present invention provides a wireless method and device for compiling and retrieving information from a server-residing database by means of a handheld device.

This capability also applies to telephonic devices and is not limited by the form factor of the personal wireless device.

The invention applies to any form of database creation and retrieval. The retrieval applies to any database including those generated by telephonic based scheduling systems.

In this invention, the device is linked to a pharmaceutical database that permits direct verification of actual prescriptions and evaluation of doses, eliminating any human error in the interpretation or calculating of doses.

### DETAILED DESCRIPTION OF INVENTION

The present invention uses the principle of wireless communication from PDA's or telephonic devices. The principles of the present invention are also equally applicable to a wide range of wireless interactions including but not necessarily limited to the following:

In healthcare, time is money and mistakes can be fatal. This disclosure introduces the capability of not being fettered to any physical location or terminal in extracting or recording medical information about a patient. The instantaneous availability of medical history and the capability of instantly recording the same frees up the practitioner and improves his efficiency in the performance of his activities, through the capability of wirelessly communicating with a server to create, access, modify, and retrieve database information.

A method of restricting access into the database by requiring secure user authentication. Instant access through the airwaves is not much use and can be wrought with danger of unauthorized access if a procedure is not established to guarantee the integrity, confidentiality, and privacy of such data. The methods disclosed here, not only ensures privacy for the primary physician but the security is such that outside services including outside physicians, consulting physicians, EMS personnel in whatever means of delivery can access the database with no threat of compromise.

A method of collecting physician profiles. In this age, obtaining instantaneous physician history is just as important as patient medical history. This disclosure ensures instantaneous secure physician profile retrieval.

A method of collecting and storing diagnosis information and wirelessly entering it into a database. In this disclosure, the patient diagnosis information is instantaneously entered into the patient electronic database. There is no error involved in the transmission. All personnel in the line of treatment of the patient, with the requisite clearance can have access to the same information entered by the physician.

A method of generating and collecting treatment information and storing it in a database.

The instantaneous availability of current and past treatment information is disclosed here. Attending physicians, nurses and other medical personnel can remotely cross-reference treatment history without having to request ahead of time the delivery of the patient file. Quite often, this file can be very bulky and it is not practical to carry all the files around. In practice, only sections of files are retrieved. This disclosure places the totality of the patient's treatment history at the fingertips of the treatment personnel.

A method of ordering, reviewing, and reporting laboratory diagnosis. The accurate and timely dissemination of laboratory results could make a difference in the survivability of the patient. This invention discloses a method of wireless transmittal of lab requests from the attending physician to the diagnosis lab even if the lab is off-site or is an institution not affiliated with the medical institution. This saves valuable time. Additionally, the lab results can be wirelessly transmitted to the host hospital upon completion, significantly accelerating medical care.

A method of generating, collecting, storing, and retrieving prescription information as part of treatment regiment. One of the persistent causes of malpractice is the miscommunication between the attending physician prescribing the medicine and the pharmacy or nurse dispensing the medication. With access to a common electronic database, accessed wirelessly, the chances of mis-delivery of medication are essentially eliminated or significantly reduced.

A method of fault-free prescription by physician by access to pharmaceutical database. The proliferation in pharmacology can cause even the most diligent physician to mis-prescribe. If not in name, in dosage. This invention discloses an interactive link to national pharmacological databases with text searching capabilities. The interactivity not only ensures accurate prescription but the auto-dosage feature in this disclosure, shows recommended dosages based upon patients' vital statistics and medical history.

A method of generating and storing physician notes. Well over 40 percent of a physician's time is spent in documentation. Transcribing notes from his tape recorder to text and transmitting that to the patient file. This is one facet of healthcare delivery that is drudgery but essential. It degrades the physician's efficiency and in time his effectiveness. This invention discloses a method for wirelessly and instantaneously creating the notes and saving them in the patient's file. What is disclosed also includes the voice activation and recognition assisted documentation. Where, in the time it took to dictate the notes into tape recorders, the same notes are converted from speech into meaningful data items that are inserted into the database.

In order to accomplish this invention, this disclosure describes a unique programming methodology that maintains wireless connections to database servers. The said programming methodologies also specify unique methods for storing, retrieving, and modifying records in such databases.

The said programming disclosed here also interfaces with existing and legacy installed database and information manipulation software and pulls information from the database and configures and maps into viewable and editable format for the wireless device.

Only the preferred embodiment of the invention and but a few examples of its versatility are shown and described in the present disclosure. It is to be understood that the invention is capable of use in various other combinations and environments and is capable of changes or modifications within the scope of the inventive concept as expressed herein.

What is claimed is:

1. A method of wirelessly communicating with a server to create, access, modify, and retrieve database information.

2. A method of claim 1 in which the database is patient information in a hospital.

3. A method of claim 1 in which the database is any information in a healthcare services establishment.

4. A method of claim 1 in which the database access is pre-admission information.

5. A method of claim 1 in which the pre-admission database is created by remote telephony.

6. A method of claim 1 in which the database is post discharge patient history.

7. A method of claim 1 in which the database generation is keyboard entry.

8. A method of claim 1 in which the patient history is electronically scanned.

9. A method of claim 1 in which the database is wirelessly generated.

10. A method of claim 1 in which the database is electronically transmitted form one entry point to the other such as by email.

11. A method of claim 1 in which the database is generated by any screen capturing technology such as screen scraping.

12. A method of restricting access into the database by requiring secure user authentication.

13. A method of claim 12 in which the authentication is by wireless entry.

14. A method of claim 12 in which the authentication between the handheld and the database is encrypted.

15. A method of claim 12 in which the authentication is by unique login profiles comprising user name and password for example.

16. A method of collecting physician profiles.

17. A method of collecting patient profile.

18. A method of claim 17 in which the profile includes patient history.

19. A method of claim 17 in which the profile includes medical history.

20. A method of claim 17 in which the profile includes allergenic reactions.

21. A method of claim 17 in which the profile includes vital statistics.

22. A method of collecting and storing diagnosis information and wirelessly entering it into database.

23. A method of claim 22 in which the information retrieval is wireless.

24. A method of claim 22 in which the storing of the information is wireless.

25. A method of claim 22 in which both the storing and retrieval is wireless.

26. A method of claim 22 in which the storing and retrieval is simultaneous.

27. A method of claim 22 in which the collection and retrieval can be viewed simultaneously in a split screen.

28. A method of claim 22 in which the retrieval is item-linked to collected information.

29. A method of generating and collecting treatment information and storing in a database.

30. A method of claim 29 in which the generation, collection, and storing is done via wireless device.

31. A method of ordering, reviewing, and reporting laboratory diagnosis.

32. A method of claim 30 in which laboratory diagnosis includes blood, stool, and urine.

33. A method of claim 30 in which the laboratory diagnosis includes tissue analysis.

34. A method of claim 30 in which the lab work includes x-rays and other related radiographic analysis.

35. A method of claim 30 in which the lab analysis includes nephrologic and other soft tissue analysis such as VPD.

36. A method of claim 30 in which the analysis covers all infections and diseases.

37. A method of claim 30 in which the analysis covers coronary ailments.

38. A method of claim 17 in which the information is retrieved by Emergency Medical Services personnel.

39. A method of claim 17 in which the EMS personnel is at emergency site or in transit and includes transmission of patient information and status.

40. A method of generating, collecting, storing, and retrieving prescription information as part of treatment regimen.

41. A method of claim 40 in which prescription information is stored and retrieved wirelessly.

42. A method of claim 40 in which the database retrieval is by pharmacist.

43. A method of claim 40 in which the retrieval is by attending nursing practitioners.

44. A method of claim 40 in which the prescription information is transmitted electronically or wirelessly across entities for example servers.

45. A method of claim 40 in which the retrieval is by EMS personnel.

46. A method of fault-free prescription by physician access to pharmaceutical database.

47. A method of claim 46 in which the access is wireless.

48. A method of claim 46 in which claim 47 is supplemented by internet access.

49. A method of claim 46 in which the prescription dosage is automatically determined.

50. A method of claim 46 in which the pharmaceutical database is linked to patient history.

51. A method of claim 46 in which the prescription lookup is enhanced by autotext recognition capability.

52. A method of generating and storing physician notes.

53. A method of claim 52 in which the notes storage is by wireless device.

54. A method of claim 52 in which the notes generation and storage is by voice recognition.

55. A method of claim 52 in which the notes are authenticated electronically.

56. A method of claim 52 in which the authentication is by electronic signature and date-stamp.

57. A method of claim 52 in which the authentication is wireless.

58. A method of claims 1, 9, 13, 22, 24, 25, 30, 41, 44, 47, 53, and 57 in which the wireless device is a computer.

59. A method of claims 1, 9, 13, 22, 24, 25, 30, 41, 44, 47, 53, and 57 in which the wireless device is a laptop computer.

60. A method of claims 1, 9, 13, 22, 24, 25, 30, 41, 44, 47, 53, and 57 in which the wireless device is a PDA.

61. A method of claims 1, 9, 13, 22, 24, 25, 30, 41, 44, 47, 53, and 57 in which the wireless device is a telephone.

62. A method of claims 1, 9, 13, 22, 24, 25, 30, 41, 44, 47, 53, and 57 in which access is by internet.
